(19) United States
(12) Patent Application Publication
(10) Pub. No.: US 2014/0172547 A1
(43) Pub. Date: Jun. 19, 2014

(54) Scoring Online Data for Advertising Servers

(71) Applicant: SAS INSTITUTE INC., Cary, NC (US)

(72) Inventors: Revathi Subramanian, San Diego, CA (US); Vijay S. Desai, San Diego, CA (US)

(73) Assignee: SAS Institute Inc., Cary, NC (US)

(21) Appl. No.: 13/719,862

(22) Filed: Dec. 19, 2012

(51) Int. Cl. G06Q 30/02

(52) U.S. Cl. CPC G06Q 30/0246
USPC 705/14.45

(57) ABSTRACT

Systems and methods for using online activity data in implementing a marketing strategy are provided. A system and method can include generating, on a computing device, variables using signature data that includes historic clickstream data and current clickstream data associated with an entity. A subset of the variables can be identified using a covariance matrix for the variables. Scores can be generated by applying the subset of the variables to models. Weighted scores can be generated by associating weights with the scores. The weighted scores can be used for selecting online advertisements. Target data can be received that includes online advertisement click data associated with the entity. New scores of the current data can be generated using the models. The weights associated with the new scores can be modified using the target data.

### TECHNICAL FIELD

The present disclosure generally relates to computer-implemented systems and methods for scoring online data using models in real-time.

### BACKGROUND

Marketing strategies can involve transmitting advertisements for display in web browsers of entities. Systems and methods can provide data on which advertisements can be selected for transmission.

### SUMMARY

In accordance with the teachings provided herein, systems and methods for using online activity data in implementing a marketing strategy are provided.

For example, a computer-implemented method can include generating, on a computing device, variables using signature data that includes historic clickstream data and current clickstream data associated with an entity. A subset of the variables can be identified using a covariance matrix for the variables. Scores can be generated by applying the subset of the variables to models. Weighted scores can be generated by associating weights with the scores. The weighted scores can be used for selecting online advertisements. Target data can be received that includes online advertisement click data associated with the entity. New scores of the current data can be generated using the models. The weights associated with the new scores can be modified using the target data.

In another example, a system is provided that includes a server device. The server device includes a processor and a non-transitory computer-readable storage medium containing instructions which when executed on the processor cause the processor to perform operations. The operations include generating variables using signature data that includes historic clickstream data and current clickstream data associated with an entity. A subset of the variables can be identified using a covariance matrix for the variables. Scores can be generated by applying the subset of the plurality of variables to models. Weighted scores can be generated by associating weights with the scores. The weighted scores can be used for selecting online advertisements. Target data, including online advertisement click data associated with the entity, can be received. New scores of the current clickstream data can be generated using the models. The weights associated with the new scores can be modified using the target data.

In another example, a computer-program product tangibly embodied in a non-transitory machine-readable storage medium is provided that includes instructions that can cause a data processing apparatus to generate variables using signature data that includes historic clickstream data and current clickstream data associated with an entity. A subset of the variables can be identified using a covariance matrix for the variables. Scores can be generated by applying the subset of the plurality of variables to models. Weighted scores can be generated by associating weights with the scores. The weighted scores can be used for selecting online advertisements. Target data, including online advertisement click data associated with the entity, can be received. New scores of the current clickstream data can be generated using the models. The weights associated with the new scores can be modified using the target data.

In another example, a server device is provided that includes a processor and a non-transitory computer-readable storage medium containing instructions which when executed on the processor cause the processor to perform operations. The operations include scoring current clickstream data associated with an entity using models to generate scores. Weights are associated with the scores. Target data associated with the entity and the scores are used in a re-weighting process to generate new weights. The weights associated with the scores are replaced with the new weights to generate weighted scores that are usable for online advertising selection.

In another example, a computer-implemented method can include initializing, on a computing device, a first subset of scores from a scoring process of current clickstream data and target data associated with an entity. The maximum score and the minimum score of the array are computed. The array is retained when an incoming score is less than the minimum score of the array. The minimum score is replaced when the incoming score is greater than the minimum score of the array. Results in the array can be provided to an advertising server for use in selecting an online advertisement to send to the entity.

The details of one or more embodiments are set forth in the accompanying drawings and the description below. Other features and aspects will become apparent from the description, the drawings, and the claims.

### BRIEF DESCRIPTION OF THE DRAWINGS

FIG. 1 shows an example of an environment that includes a data processing subsystem that can communicate with other devices using a network.

FIG. 2 shows a block diagram of an example of the data processing system of FIG. 1.

FIG. 3 shows an example of a data flow diagram that includes processes for generating models.

FIG. 4 shows a flow chart of an example of a process for routing data.

FIG. 5 shows a block diagram of an example of a server device of FIG. 2.

FIG. 6 shows a flow chart of an example of a process for providing scores associated with modified weights.

FIG. 7 shows an example of a data flow diagram that includes processes for providing scores for online advertising selection.

FIG. 8 shows an example of a data flow diagram that includes scoring processes.

FIG. 9 shows an example of a signature for an entity.

FIG. 10 shows a flow chart of an example of a process for filtering scores.

Like reference numbers and designations in the various drawings indicate like elements.

### DETAILED DESCRIPTION

Certain aspects include systems and methods for using current and historical clickstream data in connection with selecting marketing offers for transmission to an entity in a real-time manner. Scores can be generated using models and from historical and current clickstream data associated with an entity. Scores can be associated with weights and may indicate a likelihood that the entity will respond to a marketing offer, such as by clicking on an advertisement. The weights can be modified based on target data, such as advertising click data associated with the entity, and the scores with modified weights can be used for selecting an advertisement to be delivered for display in a web browser.

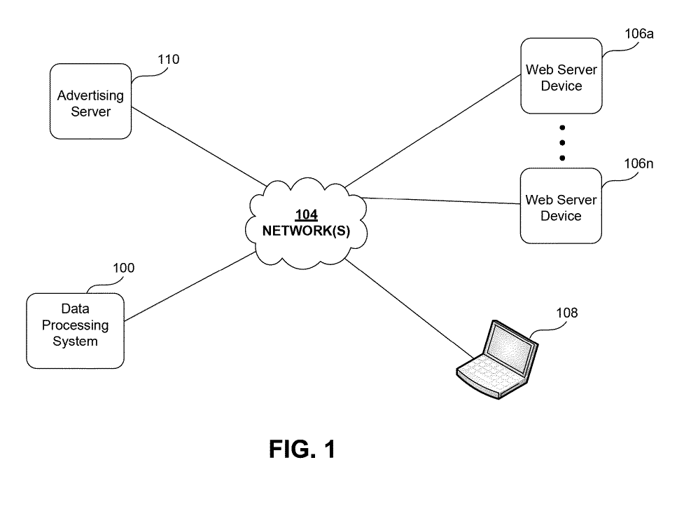

FIG. 1 is an example of an environment in which certain aspects may be implemented using a data processing system 100. The data processing system 100 can communicate through one or more networks 104 with other devices, such as web server devices 106a-n, a computing device 108, such as a computer that can display content in a web browser, and an advertising server 110.

The web server devices 106a-n may be devices that can provide web pages or other web-based content to the computing device 108 and receive requests and other information about user activity in connection with the web pages or other web-based content from the computing device 108. The advertising server 110 may be a device that can provide advertisements, such as advertisements that can be displayed with web pages provided by the web server devices 106a-n.

The data processing system 100 can receive data that includes current clickstream data and target data from the web server devices 106a-n and/or advertising server 110 about user activity. In some aspects, the current clickstream data is dynamically received in real-time and the target data is received periodically. Examples of clickstream data (current and/or historic) include an Internet Protocol (IP) address, page click rate, conversion rate, persistence, size of packet sent to the computing device 108 or received from the computing device 108, length of connection, page request instances, type of content requested, placement on a webpage of a user selection, and frequency of page requests. In some aspects, clickstream data can include other types of data, such as frequently requested web content, type of video or other rich media content requested, and selections by users other than dicks using an input device. For example, clickstream data can include selections made using gestures, touch, or stylus. Examples of target data include IP address and advertising click data that can include an instance of a selection by a user via a click using an input device or via another selection indication of an advertisement or other content provided to the computing device 108.

The data processing system 100 can process the current data and the target data using historical data to output one or more scores that are usable for selecting an advertisement to send to the computing device 108. The advertisement, for example, may be presented in text, audio, video, graphical data, electronic data, non-electronic data or some combination thereof.

In some aspects, the advertising server 110 can receive the scores from the data processing system 100, select an advertisement based on the scores, and transmit the selected advertisement to the computing device 108 through the network 104. For example, the advertising server 110 can decide the appearance of an advertising offer, even selecting from different appearances for an offer regarding a product.

Although depicted separately, the data processing system 100 may include the advertising server 110 and/or one or more of the web server devices 106a-n.

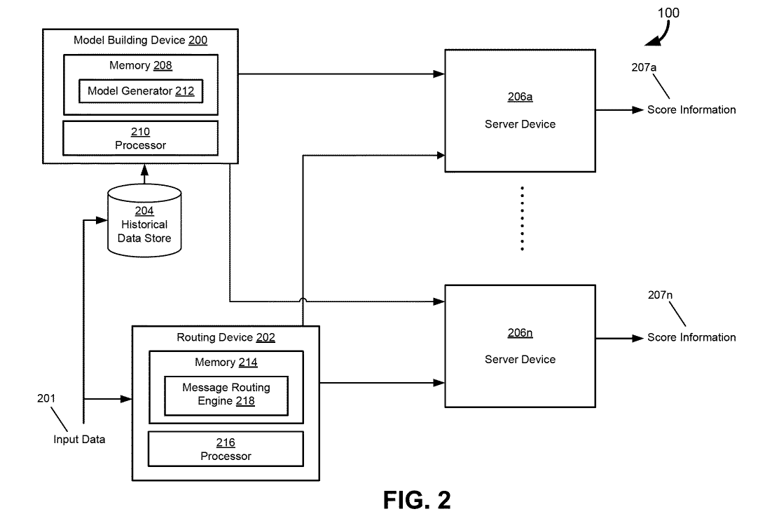

FIG. 2 depicts a block diagram with an example of the data processing system 100 according to one embodiment. Other embodiments may be utilized. The data processing system 100 includes a model building device 200, a routing device 202, a historical data store 204, and server devices 206a-n. The data processing system 100 can process input data 201, which can include current data and target data, and output score information 207a-n, which may include scores and/or weighted scores usable for selecting an advertisement. Although depicted as separate devices, one device may be used that performs actions of the model building device 200, the routing device 202, the historical data store 204, and the server devices 206a-n

Input data 201 can be received and stored in the historical data store 204. The historical data store 204 can be a device that includes a non-transitory computer-readable memory on which data and code can be stored for access by the model building device 200. Historical data associated with entities can be stored in the historical data store 204. Examples of the historical data store 204 can include relational database management systems (RDBMS), a multi-dimensional database (MDDB), such as an Online Analytical Processing (OLAP) database, Apache™ Hadoop® software, etc. In some aspects, the model building device 200 or the routing device 202 includes the historical data store 204.

Data from the historical data store 204 can be used by the model building device 200 to generate models. A model may be an algorithm or other operation to which model variables can be applied. In some aspects, the model may be a predictive model. The model building device 200 includes a processor 210 that can execute code stored on a tangible computer-readable medium in a memory 208, to cause the model building device 200 to perform actions. The model building device 200 may be any device that can process data and execute code that is a set of instructions to perform actions. Examples of the model building device 200 include a database server, a web server, desktop personal computer, a laptop personal computer, a server device, a handheld computing device, and a mobile device.

Examples of the processor 210 include a microprocessor, an application-specific integrated circuit (ASIC), a state machine, or other suitable processor. The processor 210 may include one processor or any number of processors. The processor 210 can access code stored in the memory 208 via a bus. The memory 208 may be any non-transitory computer-readable medium configured for tangibly embodying code and can include electronic, magnetic, or optical devices. Examples of the memory 208 include random access memory (RAM), read-only memory (ROM), a floppy disk, compact disc, digital video device, magnetic disk, an ASIC, a configured processor, or other storage device.

Instructions can be stored in the memory 208 as executable code. The instructions can include processor-specific instructions generated by a compiler and/or an interpreter from code written in any suitable computer-programming language. The instructions can include an application, such as a model generator application 212, that, when executed by the processor 210, can cause the model building device 200 to generate models.

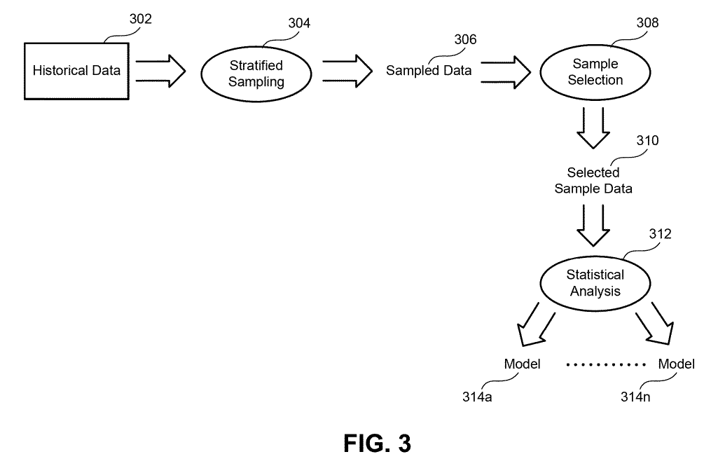

FIG. 3 is a data flow diagram that depicts an example of certain processes that can be performed by the model building device 200 of FIG. 2.

As shown in FIG. 3, the model building device 200 uses historical data 302 from the historical data store 204. Historical data 302 may include historical current data and historical target data. For example, historical data 302 can include historic clickstream data and/or historic advertising click data. In some aspects, the historical data 302 includes previously generated model variables. The model generator application 212 can perform a stratified sampling process 304 on the historical data 302 to generate sampled data 306. Sampled data 306 can include historical data 302 reduced in data size or otherwise pertinent historical data.

The model generator application 212 can perform a sample selection process 308 on the sampled data 306 to generate selected sample data 310. For example, the model generator application 212 can include a high-performance statistical analysis engine that selects samples from the sampled data 306 based on configured criteria and statistical analysis. An example of a high-performance analysis engine is High-Performance Analytics (HPA) SAS 9.3 software from SAS Institute Inc. in Cary, N.C. The selected sample data 310 can have a smaller size than the sampled data 306.

The model generator application 212 can perform a statistical analysis process 312 on the selected sample data 310 to generate models 314a-n. For example, the model generator application 212 can include a high-performance analysis engine and a statistical analysis engine to generate the models 314a-n from the selected sample data 310. An example of the high-performance analysis engine is HPA SAS 9.3 software. An example of the statistical analysis engine is SAS 9.2 software.

Generating the models 314a-n can include retraining existing models. Models can be generated periodically. Each of the models 314a-n can be tested in a modeling environment by the model generator application 212 prior to being implemented in production environment, such as by being provided to the server devices 206a-n in FIG. 2 for use in scoring current data from routing device 202. U.S. Pat. No. 7,788,195 to Subramanian, et al., issued Aug. 31, 2010 and titled “Computer-Implemented Predictive Model Generation Systems and Methods,” describes additional and alternative aspects of processes for generating predictive models, and is incorporated herein by reference.

Returning to FIG. 2, the routing device 202 may be any device that can route input data 201 to one or more of the server devices 206a-n, for example, based on processing load among the server devices 206a-n and/or information about the input data 201. The routing device includes a memory 214 and a processor 216. The memory 214 may be similar to the memory 208 in the model building device 200 and the processor 216 may be similar to the processor 210 in the model building device 200. The memory 214 includes a message routing engine 218 that, when executed by the processor 216, can cause the routing device 202 to performs actions such as routing input data 201 to one or more of the server devices 206a-n.

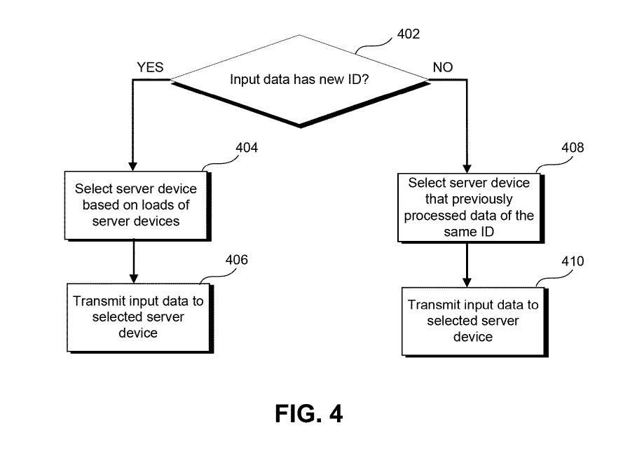

FIG. 4 depicts a flow chart with an example of process for routing input data by the routing device 202.

In decision block 402, the message routing engine 218 analyzes the input data to determine whether the input data is associated with a new identifier that has not been processed by the message routing engine 218. For example, current data and target data associated with the same IP address may be associated with the same identifier.

If the input data is associated with a new identifier, the message routing engine 218 selects a server device from available server devices 206a-n in block 404 based on loads of the server devices so that the processing load is as evenly divided among the server devices 206a-n as possible. In block 406, the message routing engine 218 transmits the input data to the selected server device.

If the input data is not associated with a new identifier, the message routing engine 218 selects the server device that previously processed data of the same identifier in block 408. For example, the message routing engine 218 may store in memory 214 an association between server devices 206a-n and input data identifiers. In block 410, the message routing engine 218 transmits the input data to the selected server device.

Input data 201 routed to the server devices 206a-n can be processed by the server devices 206a-n and score information can be outputted that is usable for selecting online advertisements.

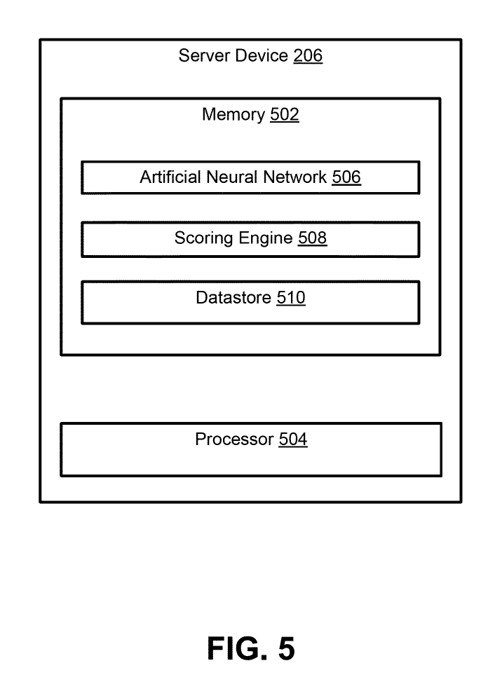

FIG. 5 depicts a block diagram with an example of a server device 206. The server device 206 includes a memory 502 and a processor 504. The memory 502 may be similar to the memory 208 in the model building device 200 and the processor 504 may be similar to the processor 210 in the model building device 200. Included in memory 502 are an artificial neural network 506, a scoring engine 508, and a datastore 510. The artificial neural network 506 may include, for example, any mathematical model that is adaptive. An example of the artificial neural network 506 is a neural network employing Self-Organizing Neural Network Arboreturn (SONNA) capability. The datastore 510 may be a relational database, a flat-file database, triplestore, or other data storage device. The scoring engine 508 may be code that, when executed by the processor 504, can cause the server device 206 to perform actions.

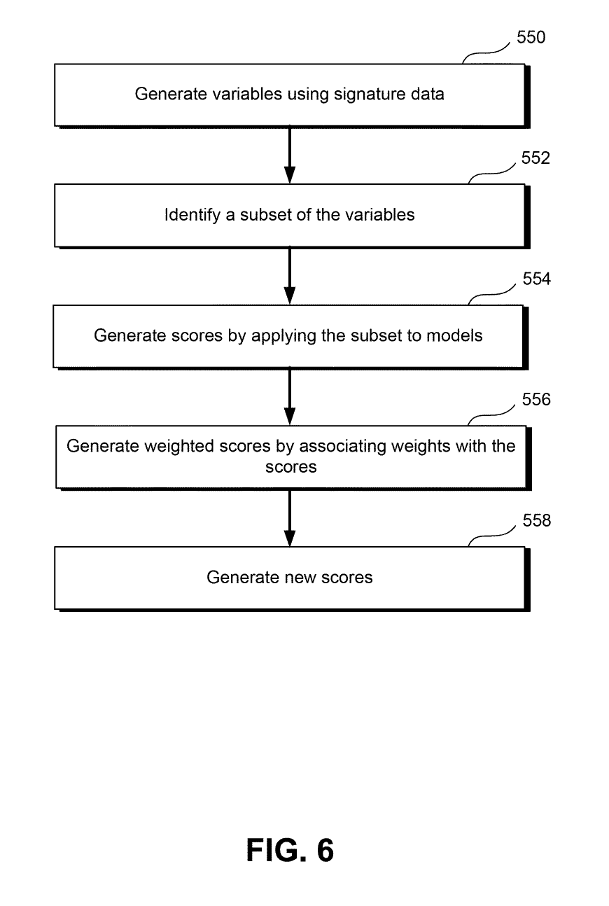

FIG. 6 is a flow chart with an example of a process for providing scores associated with modified weights that can be performed by the server device 206 of FIG. 5. In block 550, the server device 206 generates variables using signature data. The variables may be model variables. The signature data can include historic clickstream data associated with an entity and current clickstream data associated with the entity.

In block 552, the server device 206 identifies a subset of the variables. For example, the server device 206 may use a covariance matrix for the variables to identify a subset of the variables that includes or otherwise represents most of the information in the variables.

In block 554, the server device 206 generates scores by applying the subset of variables to models. The server device 206 may apply the subset of variables to the models by executing the models with the subset of variables included with the models. Each score may correspond to an advertising category. For example, one score may correspond to an advertising category of a luxury electronic household good, while another score may correspondence to an advertising category of a staple grocery item.

In block 556, the server device 206 generates weighted scores by associating weights with the scores. Each score can be associated with a weight. In some aspects, the scores are associated with weights so that the sum of the weights equals one. Initially, the weights may be the same value. In other aspects, the weights associated with different scores may have different values. The weighted scores can be used for selecting online advertisements to send to the entity.

In block 558, the server device 206 generates new scores using the signature data. The signature data may be the same signature data or updated with new current clickstream data. The new scores can be associated with the same weights as the previously generated scores. In some aspects, the new scores can be used in selecting online advertisements. In other aspects, weights associated with the new scores can be modified using target data and the new scores with modified weights can be used in selecting online advertisements.

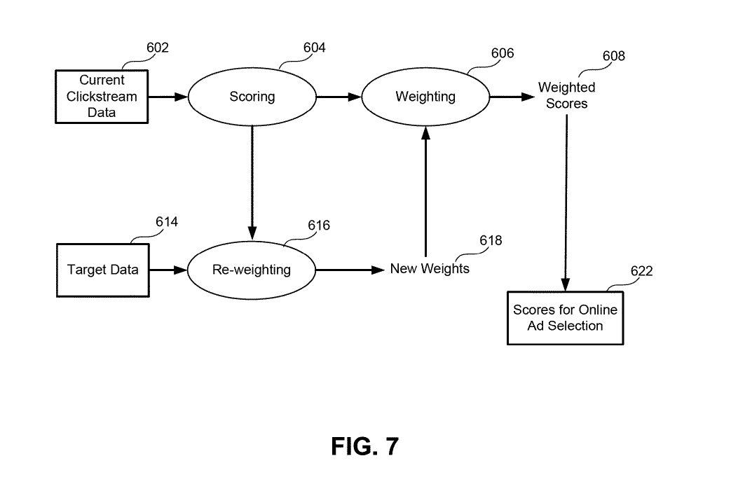

FIG. 7 is a data flow diagram that depicts an example of certain processes that can be performed by the server device 206 of FIG. 5.

The server device 206 can apply a scoring process 604 and weighting process 606 to current clickstream data 602 associated with an entity and routed to the server device 206 to generate weighted scores 608. Examples of an entity include a device, a person, and a location.

The server device 206 can apply a re-weighting process 616 to scores from the scoring process 604 using target data 614 associated with the entity and routed to the server device 206. For example, current clickstream data 602 that is new can be scored using models and the re-weighting process 616 can be applied to the new scores using the target data 614. The target data 614 may include advertisement click data associated with advertisements provided to the entity and selected based on previously provided scores. Re-weighting can include generating new weights 618 based on the target data 614 to apply to scores.

The new weights 618 can be used in the weighting process 606 in which the new weights 618 replace the weights of the scores. The weighted scores 608, with modified weights, can be provided as scores for online advertising selection 622. Each of the scores with modified weights may correspond, for example, to a particular advertising offer or an advertising category. The online advertising selection process can involve selecting, based on scores with modified weights, advertisements to which the entity may be more likely to respond. For example, the target data indicates that an advertisement associated with a particular category was clicked, the weight of the score associated with that advertisement can be increased. In some aspects, the scores with modified weights can be provided substantially in real-time with respect to receiving the target data.

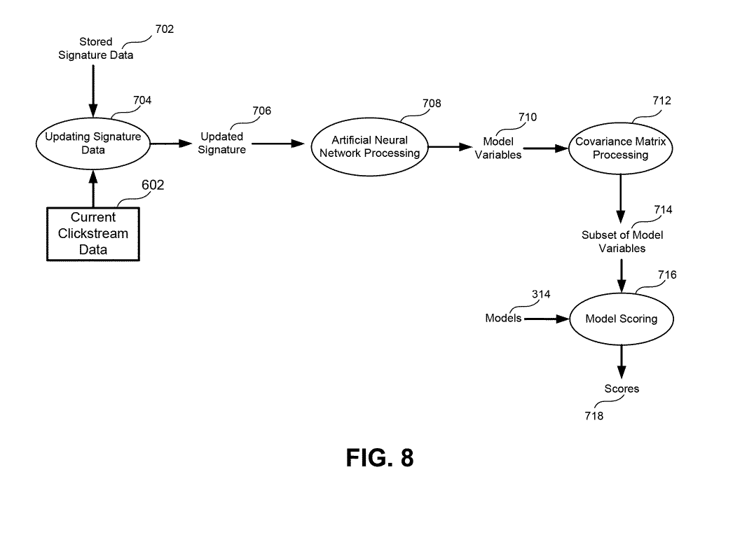

FIG. 8 is a data flow diagram that depicts an example of a scoring process.

The scoring engine 508 uses the current clickstream data 602 associated with the entity and stored signature data 702 in a process of updating signature data 704. The stored signature data 702 is historical data associated with the entity and is stored in a signature in database 102, for example. A signature may be, for example, a compilation of historical data of web-based activity types associated with the entity. One signature record may be stored for each entity (e.g., IP address, location, person, etc.). Signature data can be updated with each instance of new online activity data that is received. Examples of types of signature data include a type of web page accessed, amount of time on the web page, amount of data received, and type of links on the web page that were clicked. A signature can include fields that store data of different types and/or for a certain length of time. For example, a data associated with a select number of online activity instances involving the entity can be stored as signature data. The select number of online activity instances may be a selected number of the most recent online activity instances involving the entity. Different types of data can be stored for different connections.

The signature data can be updated, for example, by removing the oldest data in a relevant field and adding relevant types of current data to a relevant field in a relevant signature. The length of time that a particular type of signature data is stored in the signature may vary based on the type of data. For example, fifteen generations of a type of signature data may be stored for a first entity, while only six generations of the same type of signature data may be stored for a second entity that is involved in online activity less frequently than the first entity.

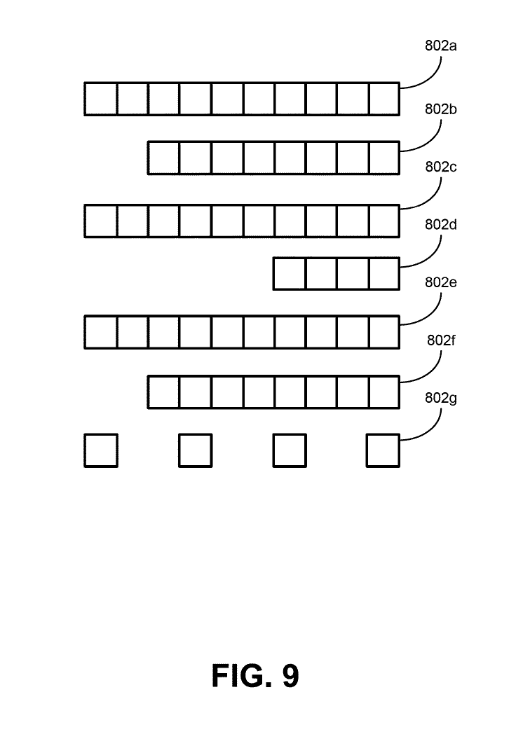

FIG. 9 depicts an example of a signature according to one embodiment. The signature includes records 802a-g, where each of the records 802a-g corresponds to a different type of signature data. Each of the records 802a-g includes a selected number of fields in which signature data can be stored. The number of fields may be representative of the length of time a particular type of data is stored. For example, record 802a includes ten fields, which can represent that the signature data of a type associated with record 802a for the last ten instances of online activity to be stored in the record 802a. Record 802d includes four fields, which can represent that the signature data of a type associated with record 802d for the last four instances of online activity to be stored in the record 402d.

Returning to FIG. 8, the scoring engine 508 applies an artificial neural network process 708 to the updated signature 706. For example, the artificial neural network 506 can be used to process the updated signature 706 to generate model variables 710. Model variables 710 may be information derived from the signature data and related (or potentially related) to factors associated with marketing. In some aspects, the scoring engine 508 creates as many model variables 710 as possible and applies covariance matrix processing 712 to the model variables 710 to identify a subset of model variables 714. For example, a covariance matrix of the model variables 710 can be generated and used to identify the subset of model variables 714 that captures a high percentage of information in the covariance matrix. The scoring engine 508 can apply a model scoring process 716 to the subset of model variables 714 using models 314 to generate scores 718.

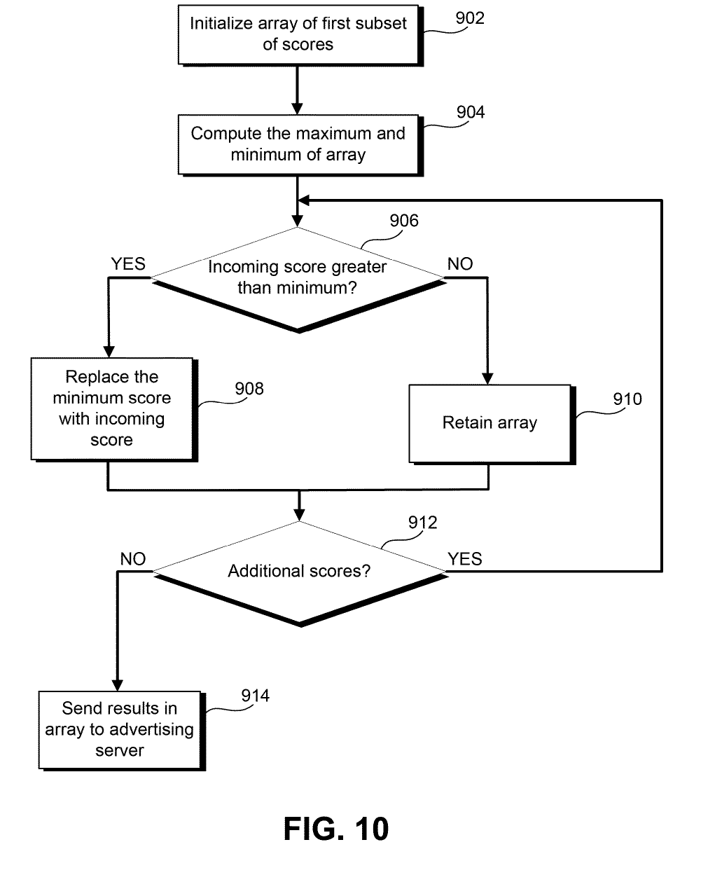

FIG. 10 is a flow chart with an example of process for filtering scores. Filtering scores can include selecting certain scores (e.g., top scores) to provide for an online advertising selection process instead of all scores. In block 902, the server device 206 initializes an array of a first subset of scores from all of the generated scores. For example, the first ten scores may be included in the array.

The maximum value and the minimum value of scores in the array are computed in block 904. For example, the scores may represent values on a certain scale in which one end of the scale indicates a very high likelihood that an entity will respond to a marketing offer associated with the score and the other end of the scale indicates a very low likelihood that the entity will respond to a marketing offer associated with the score.

In decision block 906, the server device 206 determines whether an incoming score (e.g., the next score) is greater than the minimum score. If the incoming score is greater than the minimum score, the server device 206 replaces the minimum score with the incoming score in block 908. If the incoming score is not greater than the minimum score, the server device 206 retains the array in block 910.

In decision block 912, the server device 206 determines whether any additional scores exist, such as scores related to the signature data as updated with the most recent online activity instance. If there are one or more additional scores, the process returns to decision block 906. If there are no additional scores, the scores in the array are provided to the advertising server 110 in block 914, or otherwise provided.

In other aspects, the filtering process includes using a sorting algorithm, such as a “river sort” algorithm, to determine the top scores, which may include the top score, the top three scores, the top ten scores, etc.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus.

The computer readable medium can be a machine readable storage device, a machine readable storage substrate, a memory device, a composition of matter effecting a machine readable propagated communication, or a combination of one or more of them. The term “data processing device” encompasses all apparatus, devices, and machines for processing data, including by way of example a programmable processor, a computer, or multiple processors or computers. The device can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code), can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and a device can also be implemented as, special purpose logic circuitry, e.g., an FPGA (field programmable gate array) or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, the actions recited in the claims can be performed in a different order and still achieve desirable results.

What is claimed is:

1. A computer-implemented method, comprising:
generating, on a computing device, a plurality of variables using signature data that includes historic clickstream data and current clickstream data associated with an entity;
identifying a subset of the plurality of variables using a covariance matrix for the plurality of variables;
generating scores by applying the subset of the plurality of variables to models;
generating weighted scores by associating weights with the scores, the weighted scores being usable for selecting online advertisements;
receiving target data including online advertisement click data associated with the entity;
generating new scores of the current data using the models; and
modifying the weights associated with the new scores using the target data.

2. The method of claim 1, further comprising generating the models periodically.

3. The method of claim 2, wherein generating the models periodically includes:
generating sampled data by applying a stratified sampling process on historical data;
selecting samples from the sampled data; and
performing a statistical analysis process on the selected samples to generate the models.

4. The method of claim 2, wherein generating the models periodically includes retraining the models.

5. The method of claim 1, further comprising:
dynamically receiving the current clickstream data in real-time.

6. The method of claim 1, further comprising:
routing input data that includes at least one of the current clickstream data or the target data to a server device of a plurality of server devices for processing.

7. The method of claim 6, wherein routing the input data includes routing the input data to the server device that previously processed data having an identifier that is the same as the identifier associated with the input data.

8. The method of claim 6, wherein routing the input data includes evenly distributing the input data among the plurality of server devices when the input data is associated with a new identifier.

9. The method of claim 1, wherein generating the plurality of variables using signature data includes using an artificial neural network.

10. The method of claim 1, further comprising filtering the new scores associated with modified weights by updating an array of a selected number of a subset of the new scores.

11. A system, comprising:
a server device that includes:
a processor; and
a non-transitory computer-readable storage medium containing instructions which when executed on the processor cause the processor to perform operations including:
generating a plurality of variables using signature data that includes historic clickstream data and current clickstream data associated with an entity;
identifying a subset of the plurality of variables using a covariance matrix for the plurality of variables;
generating scores by applying the subset of the plurality of variables to models;
generating weighted scores by associating weights with the scores, the weighted scores being usable for selecting online advertisements;
receiving target data including online advertisement click data associated with the entity;
generating new scores of the current clickstream data using the models; and
modifying the weights associated with the new scores using the target data.

12. The system of claim 11, further comprising a model building device that is configured for generating the models periodically.

13. The system of claim 12, wherein the model building device is configured for generating the models periodically by:
generating sampled data by applying a stratified sampling process on historical data;
selecting samples from the sampled data; and
performing a statistical analysis process on the selected samples to generate the models.

14. The system of claim 12, wherein generating the models periodically includes retraining the models.

15. The system of claim 11, wherein the server device includes instructions configured to cause the processor to perform operations including:
dynamically receiving the current clickstream data in real-time.

16. The system of claim 11, further comprising a routing device configured for routing input data that includes at least one of the current clickstream data or the target data to the server device of a plurality of server devices for processing.

17. The system of claim 16, wherein the routing device is configured for routing the input data to the server device that previously processed data having an identifier that is the same as the identifier associated with the input data.

18. The system of claim 16, wherein the routing device is configured for evenly distributing the input data among the plurality of server devices when the input data is associated with a new identifier.

19. The system of claim 11, wherein generating the plurality of variables using signature data includes using an artificial neural network.

20. The system of claim 11, wherein the server device includes instructions configured to cause the processor to perform operations including:
filtering the new scores associated with modified weights by updating an array of a selected number of a subset of the new scores.

21. A computer-program product tangibly embodied in a non-transitory machine-readable storage medium, including instructions configured to cause a data processing apparatus to:
generate a plurality of variables using signature data that includes historic clickstream data and current clickstream data associated with an entity;
identify a subset of the plurality of variables using a covariance matrix for the plurality of variables;
generate scores by applying the subset of the plurality of variables to models;
generate weighted scores by associating weights with the scores, the weighted scores being usable for selecting online advertisements;
receive target data including online advertisement click data associated with the entity;
generate new scores of the current clickstream data using the models; and
modify the weights associated with the new scores using the target data.

22. The computer-program product of claim 21, further comprising instructions configured to cause the data processing apparatus to generate the models periodically.

23. The computer-program product of claim 22, wherein instructions configured to cause the data processing apparatus to generate the models periodically includes instructions for:
generating sampled data by applying a stratified sampling process on historical data;
selecting samples from the sampled data; and
performing a statistical analysis process on the selected samples to generate the models.

24. The computer-program product of claim 22, wherein instructions configured to cause the data processing apparatus to generate the models periodically includes instructions for retraining the models.

25. The computer-program product of claim 21, further comprising instructions configured to cause the data processing apparatus to:
dynamically receive the current clickstream data in real-time.

26. The computer-program product of claim 21, further comprising instructions configured to cause the data processing apparatus to:
route input data that includes at least one of the current clickstream data or the target data to a server device of a plurality of server devices for processing.

27. The computer-program product of claim 26, wherein instructions configured to cause the data processing apparatus to route the input data includes instructions for routing the input data to the server device that previously processed data having an identifier that is the same as the identifier associated with the input data.

28. The computer-program product of claim 26, wherein instructions configured to cause the data processing apparatus to route the input data includes instructions for evenly distributing the input data among the plurality of server devices when the input data is associated with a new identifier.

29. The computer-program product of claim 21, wherein instructions configured to cause the data processing apparatus to generate the plurality of variables using signature data includes instructions for using an artificial neural network.

30. The computer-program product of claim 21, further comprising instructions configured to cause the data processing apparatus to:
filter the new scores associated with modified weights by updating an array of a selected number of a subset of the new scores.
